(19) United States
(12) Patent Application Publication
(10) Pub. No.: US 2014/0195357 A1
(43) Pub. Date: Jul. 10, 2014

(54) POINT OF SALE SYSTEM FOR MANAGING THE TIMED SALE OF PRODUCTS

(71) Applicant: Jeffrey Pollack, Chicago, IL (US)

(72) Inventor: Jeffrey Pollack, Chicago, IL (US)

(21) Appl. No.: 14/149,508

(22) Filed: Jan. 7, 2014

Related U.S. Application Data
(60) Provisional application No. 61/749,543, filed on Jan. 7, 2013.

(51) Int. Cl. G06Q 30/02

(52) U.S. Cl. CPC G06Q 30/0268
USPC 705/14.65

(57) ABSTRACT

The present invention provides a point of sale system for offering local flash sales to customers through, for example, a plurality of POS apparatuses operatively coupled to a network. The flash sales may be tied to an online flash sale site offering similar or concurrent flash sales.

### CROSS-REFERENCE TO RELATED APPLICATIONS

This application claims priority to U.S. Provisional Patent Application No. 61/749,543, filed on Jan. 7, 2013, entitled “Point of Sale System for Managing the Time Sale of Products,” by Jeffrey Pollack, which is hereby incorporated by reference in its entirety.

### TECHNICAL FIELD

The present invention relates to point of sale systems and methods for managing the timed sale of products. More specifically, the present invention relates to vending machines or a pop-up store that offers limited time sales of discounted products.

### BACKGROUND

Brick-and-mortar retail stores have traditionally been used to sell items at a discount in the “sales section” of the store. Sometimes, retail stores and/or manufacturers offload their extra products to discount retail stores that then offer the acquired products for sale at a deep discount. With the advent of online retail, many online discount stores also now perform the same function as the discount retail stores. That is, the online discount stores offer deep discounts on products that other retailers or manufacturers were unable to sell.

In order to direct business to their websites, the online discount retailers must be very savvy in how they organize their websites and present their inventory for sale. For example, many online discount retailers use “flash sales” in which a product is offered for sale at a deep discount for a limited amount of time (e.g., 12 hours, 24 hours, etc.) or until inventory of the product runs out. The online flash sale sites have proven to be very popular. However, many customers of the online flash sale sites miss the instant gratification and convenience that comes with physically purchasing a product and having immediate access to it. Therefore, there clearly exists a need for providing a point of sale system that combines the instant gratification and convenience of a local purchase with the popularity and savings associated with flash sales. Additionally, the point of sale system should avoid the high costs associated with maintaining a permanent brick-and-mortar store.

### SUMMARY

The present disclosure endeavors to provide a point of sale system that is capable of offering local flash sales that are similar to and/or tied to those currently offered by online flash sale discount retailers.

According to a first aspect, a vending machine, or similar POS apparatus, provides the localized point of sale system for the flash sales. The vending machine can be located in any well trafficked area such as building lobbies, hotels, malls, airports, retail stores, etc. Because the footprint of a vending machine is small, it can be placed in any area where space is at a premium. Vending machines also require little routine maintenance and only need to be restocked with products when inventory runs out. The information for the flash sales provided by the vending machine can be stored locally or obtained from an online database via the internet. In some aspects, the flash sales offered by the vending machine are tied to a similar flash sale that is concurrently being offered online by an online flash sale site.

According to a second aspect, a pop-up store provides the localized point of sale system for the flash sales. The pop-up store has the advantage that it can be located in virtually any space (e.g., a tent, unused retail space) and generally only requires a few employees. The flash sales offered by the pop-up store are preferably tied to an online flash sale site. However, the timing of the flash sale at the pop-up store may be longer/shorter than the online flash sale (e.g., because of different inventory levels).

According to a third aspect, a system for providing product sales to consumers comprises: a point of sale (POS) apparatus located at a first location; at least one product offered for sale at the POS apparatus; and an online flash sale web site connected to the POS apparatus via a network, wherein the sale price of the at least one product is determined by the online flash sale site.

In certain aspects, the POS apparatus is a vending machine or a pop-up store.

In certain aspects, the online flash sale site offers the at least one product for sale online.

In certain aspects, the start time of the sale at the POS apparatus and the start time of the sale at the Online flash sale web site are the same.

In certain aspects, the length of the sale at the POS apparatus and the length of the sale at the online flash sale web site are the same.

In certain aspects, the length of the sale at the POS apparatus and the length of the sale at the online flash sale web site are different.

In certain aspects, the sale price of the at least one item at the POS apparatus and the online flash sale site are the same.

In certain aspects, the POS apparatus offers a second product for sale, wherein the sale price of the second product is determined by a second online flash sale site connected to the POS apparatus.

In certain aspects, the POS apparatus comprises a touch-screen.

In certain aspects, the POS apparatus comprise an advertising display for displaying advertisements.

In certain aspects, the advertising display is configured to display a predetermined advertisement for a predetermined period of time.

In certain aspects, the predetermined advertisement comprises video.

In certain aspects, the predetermined advertisement is communicated from management server to the POS apparatus the network.

In certain aspects, the predetermined advertisement is interactive.

### DESCRIPTION OF THE DRAWINGS

These and other advantages of the present invention will be readily understood with reference to the following specifications and attached drawings wherein:

FIG. 1 illustrates a system diagram for the point of sale system according the present invention; and

FIG. 2 illustrates an example method for operating a vending machine system.

### DETAILED DESCRIPTION

Preferred embodiments of the present invention will be described hereinbelow with references to the accompanying drawings. In the following description, well-known functions or constructions are not described in detail, since such minutiae would obscure the invention in unnecessary detail.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments” or “invention” do not require that all embodiments of the invention include the discussed feature, advantage or mode of operation.

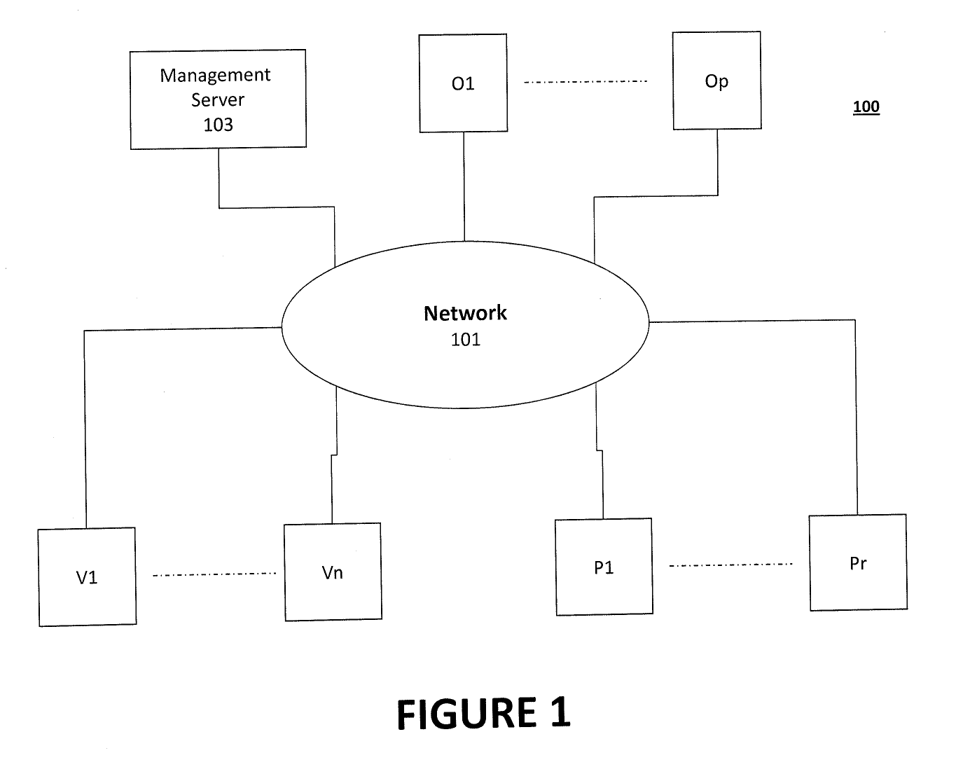

FIG. 1 illustrates an exemplary network diagram 100 in which a plurality of POS apparatuses (e.g., vending machines (V1 to Vn)) and a plurality of pop-up sale stores (P1 to Pr) are shown operatively connected to a network 101, such as the interne. In certain embodiments, it may be advantageous to wirelessly couple the vending machines and the plurality of pop-up sale stores to the network 101. Further, a management server 103 and a plurality of online flash sale sites (01 to Op) are also connected to the network 101. Accordingly, an operator may control, or otherwise communicate with, the plurality of vending machines and the plurality of pop-up sale stores through a user interface operatively couple with the network 101. The user interface may be provided through a computer, tablet, phone or other device. This enables the user to easily monitor and control the operation of the vending machines and/or stores. Similarly, any transactions at the vending machines and/or the plurality of pop-up sale stores may be communicated to the operator or a financial entity to be authorized or deposited (e.g., via a credit card processing entity or bank). Thus, the network 101 is configured to provide two way communication between the operator, vending machines and/or plurality of pop-up sale stores. That is, information between the operator, vending machines and/or plurality of pop-up sale stores may be readily communicated over the network 101.

Each vending machine (V1 to Vn) is a vending machine capable of selling a plurality of products. In certain aspects, the vending machines are touch-screen enabled vending machines capable of vending a wide variety of products (e.g., electronics, clothing, beauty products, etc.) are completely programmable and are capable of facilitating financial transactions through, for example, credit cards, cash, etc. For example, vending machines sold by ZoomSystems may be used to facilitate the functionality of the present invention. Moreover, another suitable vending machine is described by U.S. RE43,656 to Satchell, entitled “Vending machine and computer assembly.” The vending machines can either be managed on site or remotely via on board POS software. The management and programming of the vending machines is well known to those skilled in the art.

The vending machines (V1 to Vn) may be placed in any environment capable of supporting a vending machine. Ideally, the location of each vending machine is a highly trafficked area such as a hotel, airport, or mall. However, it is possible that the vending machines may also be placed in remote areas not close to other retail outlets because vending machines require little maintenance other than restocking. Alternatively, in certain aspects, larger retail spaces may be designated solely for the use of such vending machines. Accordingly, a retail space that would typically be used for a brick-and-mortar store may be used to house a plurality of vending machines for various products from various vendors. For example, a first set of vending machines may be licensed, or rented, by O1; a second set of vending machines may be licensed, or rented, by O2, and so on. The vending machines may be arranged within the retail space by, for example, vendor or product type. Accordingly, vendors may be able to lease vending machines in certain. portions of the store. As will be discuss, the vendors may manage the vending machines thought management server 103. Providing such a retail space would allow greater exposure to the vendor and greater selection to the public. Day to day operation of the various licensed or rented vending machines may be managed either by the licensees (e.g., O1, O2 . . . Op) or by the licensor pursuant to any previous agreements or contractual relations.

In some aspects, the vending machines are associated with one or more online flash sale sites (O1 to Op). For example, vending machines V1 and V2 may be associated with a first flash sale site O1 while vending machines V3 to Vn could be associated with a second online flash sale site O2. In other aspects, the vending machines are operated independently of the online flash sale sites. For example, a vending machine may be controlled by a management server 103 which is controlled by, e.g., an entrepreneur wanting to provide his/her own flash sales independent of any other retail outlet. For instance, the entrepreneur may wish to sell new and emerging brands offered at discounted/limited time offers in order to gain market penetration. The management server 103 may be controlled (e.g., by the operator) through, for example an Internet-based user interface (e.g., a GUI interface). In this example, the operator may visit a website (e.g., one hosted by the vending service), enter log on credentials, then make changes to the vending machines' operation (e.g., price, duration of sale, etc.) or check the status of the vending machines (e.g., units sold, inventory remaining, traffic, etc.). In another example, a flash sale site may be selling product X though its website while only offering product Y through a vending machine, thereby providing independent daily deal hot spot sites and/or offerings.

While the flash sale sites are generally described in relation to internet-based websites, such flash sale sites should not be limited to such internet-based websites. On the contrary, flash sale sites may also include, for example, infomercial retailers, such as those who typically sell products through printed, television and online advertisements.

Similarly, the pop-up stores (P1 to Pr) can be set up in a variety of locations. For example, a pop-up store can be operated out of a tent or in unused/awkward retail space at a brick-and-mortar retail outlet. The pop-up stores operate similar to the vending machines, except retail personnel may be required to provide the function of the vending machine (e.g., tracking inventory, pricing items, etc.), thus increasing operational costs. The same retail personnel may be enabled to manage the one or more vending machines from the pop-up stores.

In one aspect, an online flash sale site (e.g, O1) controls and manages one or more vending machines (V1 to Vn) or pop-up stores (P1 to Pr) via the internet 101. Preferably, the sales being offered by the online website may be reflected in the products being offered for sale at the vending machines and/or pop-up stores. This can be accomplished automatically by software or manually pushed out to the vending machine by an operator. For example, if an online flash sale site is currently offering a camera for sale at a heavily discounted price, this information could be communicated via the network 101 to vending machine(s) or pop-up store(s) which also offer the same sale concurrently with the online flash sale site. Then, when the online flash sale site ends the sale, the sale is also terminated at the vending machine(s) and/or pop-up store(s). However, the length of the sale offered by the online flash sale site, the vending machine(s), or the pop-up store(s) may be different. Similarly, the products being offered may also differ and need not be limited to discount products.

In some aspects, the flash sale offered by the online flash sale site, the vending machine, or the pop-up store need not be time-based. Rather, the flash sale is based on the available inventory (i.e., the flash sale lasts as long as there is inventory available). The pricing of the flash sale could also be changed over time. For example, the flash sale may initially have a price that increases/decreases in relation to the amount of time left in the sale and/or the amount of inventory left.

Each vending machine and/or pop-up store may offer a plurality of products for sale. The products may all be associated with a single online flash sale site or with multiple online flash sale sites. For example, if one online flash sale site only sells beauty products and another online flash sale site only sells clothing, the two online flash sale sites may desire to offer their products together to offset the costs associated with a vending machine or a pop-up store.

In some aspects, the products offered at the vending machines and/or pop-up stores may differ by geographic region. For example, product A may be popular in a first geographic region but not in a second geographic region. Thus, product A would only be stocked in the first geographic region. Because online flash sale sites collect data about their customers, they can use this data to effectively stock the vending machines and/or pop-up stores with products that are expected to sell in various geographic regions. Further, the online flash sale sites can tailor the sale prices offered at the vending machines and/or pop-up stores to different geographic regions. The pricing for the products can be determined from market research or from information gathered by the online flash sale sites from their online sales.

In order to entice consumers to shop at the vending machines and/or pop-up stores, the online flash sale sites may provide select customers with additional promotion codes that can be redeemed at the vending machines and/or pop-up stores for even steeper discounts.

In some aspects, to further increase traffic and revenue, each of vending machines V3 to Vn may be provided with an advertising display to display advertisement for, for example, the product being dispensed, a company operating the vending machine, or third party advertisements (e.g., paid advertisements). For example, an LCD display may be positioned on the machine at a level to attract a consumer's attention (e.g., eye level), thereby effectively operating as a billboard. While the display size is dependent on the vending machine, it is contemplated that a 32-inch display would be sufficient for this purpose. However, one of skill would recognize that the size may be increased or decreased depending on the vending machine and location of the machine.

In certain aspects, the LCD display may be programmed to display an advertisement for a predetermined period of time. By limiting the advertisement to a predetermined period of time, the advertisement display is made available for additional advertisements, thus increasing the diversity of advertisements and more effectively communicating products and/or services to the consumers. The length of the predetermined period of time may be dependent on the type of advertisement. For example, an advertisement having greater detail may require an increased period of time so that the consumers have sufficient time to comprehend what the advertisement is communicating.

It is also contemplated that the advertisement displays not be limited to static advertisements. For instance, the advertisement displays may be configured to display advertisements that include one or more images, videos and even interactive interfaces whereby a customer may interact with the advertisement using, for example, a touch screen. Accordingly, speakers may also be provided to provide the advertisement with an audio element. For example, touch monitors sold by TouchSystems may be used to facilitate the present invention. The advertisement display may be controlled either locally or over network 101. For example, advertisements may be locally loaded and stored (e.g., using a local memory device) or pushed by management server 103 via network 101 and POS software.

An interactive display is useful in instances where, for example, a customer wishes to learn more about a particular product or service and wishes to use the advertisement display to request additional information (e.g., by accessing a webpage or joining a mailing list by inputting an e-mail/mailing address). Therefore, the length of the predetermined period of time may also be dependent on the length of a video advertisement or the status of an interactive display. For example, the interactive display may be initially set to display for only time X; however, if customer interaction is detected, the timer may be suspended such that the interactive display is displayed until a termination flag is detected. The termination flag may be triggered when, for example, a customer exits, or cancels, interaction with the device or after a predetermined period of inactivity (e.g., 30 seconds to 2 minutes).

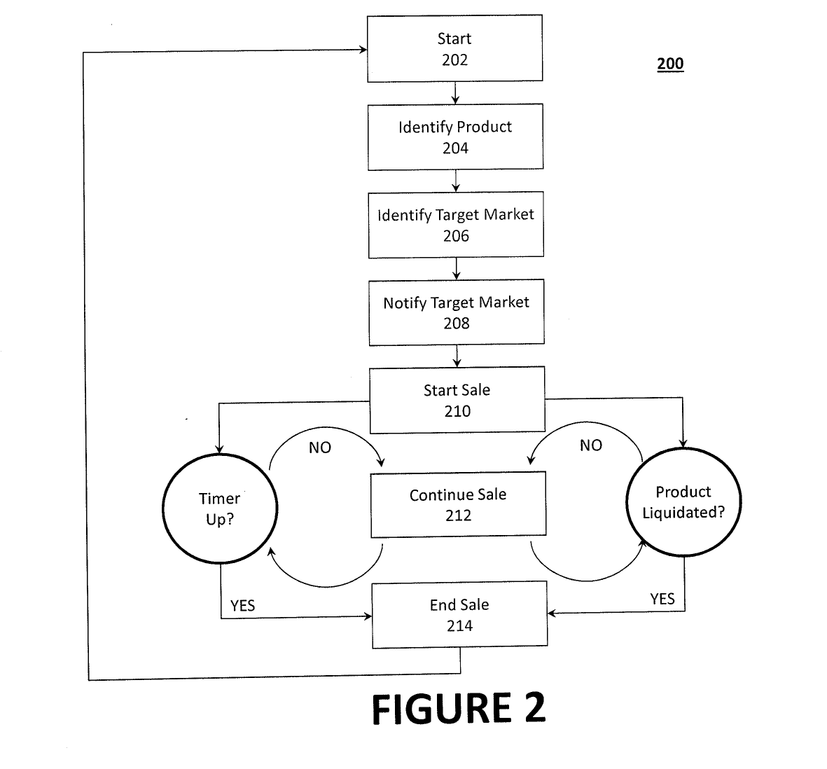

FIG. 2 provides an example method 200 for operating a vending machine system 100. After start up 202, the product to be dispensed through a vending machine is identified at step 204. Depending on the needs of the operator, the product may be the same as one that is being concurrently offered through an online deal, but need not be. For example, the operator may wish to offer X brand eyeliner through an online only deal while offering X brand lipstick through the vending machine. Once the product is identified, the operator may wish to identify the target market as step 206. In identifying the market, the operator may consider numerous consumer traits or other demographics, including, for example, gender, age, income, race, location, etc. For example, when offering X brand lipstick through a vending machine, it would be advantageous for the operator to place the vending machine in a location that would better target female consumers. At step 208, the operator may further wish to notify the target market, or subset thereof, using, for example, an e-mail blast (e.g., an e-mail sent to a group of consumers). In doing so, the operator may use existing mailing lists generated through prior transactions (e.g., sales lists, or known account holders) or may cooperate with other parties that may provide such mailing lists and any corresponding consumer traits and/or demographics. Accordingly, continuing with the X brand lipstick example, the operator would likely wish to filter the mailing list to only target the consumers who are, or are thought to be, female (e.g., not male). Additionally, the operator may consider any available market research that would help identify the target market, including, for example, the age and income range for his/her consumers. Once the target market is identified, an e-mail may be sent out to the target market and may include, for example, the product being sold, price, location of the vending machine, and, if applicable, the quantity of product available and/or any time restraints. While an e-mail blast is used in this example, other means of communication are possible, such as text messages, instant messages, phones calls (e.g., automated calls), etc.

The sale may then start at step 210. While in this example the sale starts after notifying the target market, the sale may start before or simultaneously with the identification and notification steps 206 and 208. The sale may continue at step 212 until, for example, a timer indicates that the sale is over and/or all product is liquidated (e.g., no longer available), at which point the sale is ended at 214. Depending on the desires of the operator, the routine may restart at step 202 with another product. Indeed, the operator may even log in, via a user interface, and access the one or more vending machines to change the sale parameters. For instance, the operator may wish to extend the sale, terminate the sale, or even change the prices during the sale.

While the present invention has been described with respect to what are currently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation, so as to encompass all such modifications and equivalent structures and functions.

All United States and foreign patent documents, all articles, all brochures, and all other published documents discussed above are hereby incorporated by reference into the Detailed Description.

What is claimed is:

1. A system for providing product sales to consumers comprising:
a point of sale (POS) apparatus located at a first location;
at least one product offered for sale at the POS apparatus; and
an online flash sale web site connected to the POS apparatus via a network,
wherein the sale price of the at least one product is determined by the online flash sale site.

2. The system according to claim 1, wherein the POS apparatus is a vending machine or a pop-up store.

3. The system according to claim 1, wherein the online flash sale site offers the at least one product for sale online.

4. The system according to claim 3, wherein the start time of the sale at the POS apparatus and the start time of the sale at the Online flash sale web site are the same.

5. The system according to claim 3, wherein the length of the sale at the POS apparatus and the length of the sale at the online flash sale web site are the same.

6. The system according to claim 3, wherein the length of the sale at the POS apparatus and the length of the sale at the online flash sale web site are different.

7. The system according to claim 3, wherein the sale price of the at least one item at the POS apparatus and the online flash sale site are the same.

8. The system according to claim 1, wherein the POS apparatus offers a second product for sale, wherein the sale price of the second product is determined by a second online flash sale site connected to the POS apparatus.

9. The system according to claim 1, wherein the POS apparatus comprises a touch-screen.

10. The system according to claim 1, wherein the POS apparatus comprise an advertising display for displaying advertisements.

11. The system according to claim 10, wherein the advertising display is configured to display a predetermined advertisement for a predetermined period of time.

12. The system according to claim 11, wherein the predetermined advertisement comprises video.

13. The system according to claim 11, wherein the predetermined advertisement is communicated from management server to the POS apparatus the network.

14. The system according to claim 11, wherein the predetermined advertisement is interactive.
